(19) United States
(12) Patent Application Publication
(10) Pub. No.: US 2007/0140922 A1
(43) Pub. Date: Jun. 21, 2007

(54) Cassette Retaining Device For A Microtome

(76) Inventors: Claudia Dorenkamp, Muhlhausen (DE); Stefan Kunkel, Karlsruhe (DE)

Correspondence Address: HODGSON RUSS LLP, ONE M & T PLAZA, SUITE 2000, BUFFALO, NY, 14203-2391, US

(21) Appl. No.: 11/610,550

(22) Filed: Dec. 14, 2006

(30) Foreign Application Priority Data
Dec. 17, 2005 (DE) 20 2005 019 764.5

(51) Int. Cl. B01L 3/00

(52) U.S. Cl. 422/102

(57) ABSTRACT

A cassette retaining device (1) for a microtome (2), having a base part (3), is described. The base part (3) comprises stationary stops (4) for positioning a cassette (5), and is equipped with at least one movably mounted clamping jaw (6). The cassette (5) is retainable between the stops (4) and the clamping jaw (6). In order to cool the cassette (5), the base part (3) has associated with it at least one refrigerant line (8) that may be connected to a coolant circuit of a refrigeration system.

### CROSS REFERENCE TO RELATED APPLICATIONS

This application claims priority of the German utility application 20 2005 019 764.5 filed Dec. 17, 2005, which is incorporated by reference herein.

### FIELD OF THE INVENTION

The present invention relates to a cassette retaining device for a microtome.

### BACKGROUND OF THE INVENTION

A cassette retaining device of the species for a microtome is known from DE 198 16 375 C1. The cassette retaining device for a microtome serves to receive and clamp cassettes in which the samples to be sectioned are embedded in paraffin. To ensure proper cutting of the samples, the cassettes having the embedded samples are cooled to approximately −8° C. before the actual sectioning operation. During sectioning, however, heat inevitably occurs which softens the samples and the paraffin, with the result that proper cutting cannot be ensured.

Complex cooling equipment is necessary so that the embedded sample is cooled in this instance as well. A cooling device of this kind having a temperature regulating device for the specimen receptacle is disclosed in DE 94 21 559 U1. Associated with the specimen receptacle is a specimen head on which the specimen to be sectioned can be mounted. The specimen receptacle is equipped with cooling hoses for cooling the specimen head and the specimen.

The company document “LEITZ 1512 Rotationsmikrotom, Anleitung, Liste [Rotary microtome, instructions, list] 311.530-047, April 1981, Ernst Leitz Wetzlar GmbH” discloses a microtome (Leitz 1512) having an attachable, separate “Kryomat 1700” cooling unit. Here a freezing chamber having a coolant connector hose is mounted in the specimen clamp of the microtome. The specimen stages with the samples are slid onto the freezing chamber and cooled there.

The above-described devices for sectioning cooled or frozen samples have proven successful in practical use. The above-described devices are, however, very complex and correspondingly expensive.

To ensure proper cutting, however, the heat generated by the sectioning operation must be dissipated. For this reason, in practical use the specimens are removed from the specimen receptacle and brought back to the requisite temperature on separate cooling plates. This procedure is of course very time-consuming, since each specimen change necessitates a realignment of the specimen with respect to the knife edge.

### SUMMARY OF THE INVENTION

It is therefore the object of the present invention to minimize the time expenditure when sectioning cooled or frozen samples.

This object is achieved, according to the present invention, by the features described herein. Further advantageous developments of the invention are the subject matter of the dependent claims.

The invention is notable for the fact that in order to cool the cassette, the base part has associated with it at least one refrigerant line that is connected to the coolant circuit of a refrigeration system, so that the base part is actively cooled.

In a further embodiment of the invention, the cassette retaining device and/or the base part is produced from a highly thermally conductive material, preferably from brass.

In a further embodiment of the invention, a heat absorber is associated with the base part. The result of this is that the cooled base part is thermally decoupled from the microtome.

In a development of the invention, the refrigerant line is integrated directly into the base part.

It has proven to be advantageous to arrange the refrigerant line in meander fashion running in different direction through the base part in order to ensure good cooling performance.

In a development of the invention, the base part having the refrigerant line is embodied as a separate retrofittable component that is connectable to the specimen holder or to the cassette retaining apparatus.

### BRIEF DESCRIPTION OF THE DRAWINGS

The invention will be explained in more detail with reference to two exemplifying embodiments, with the aid of the schematic drawings in which:

FIG. 1 is a view of the microtome with the cassette retaining device; and

FIG. 2 is a view of the cassette retaining device.

### DETAILED DESCRIPTION OF THE INVENTION

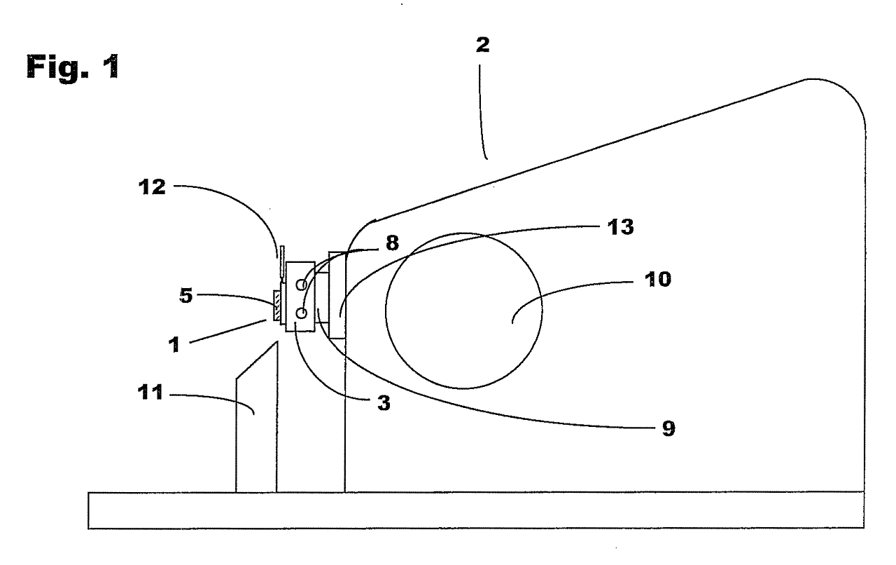

FIG. 1 is a view of a microtome 2 having a knife 11, having a drive device 10 for a specimen holder 13 on which a cassette retaining device 1 having a cassette 5 is arranged. Cassette 5 contains, embedded in paraffin, the specimen to be sectioned. By way of drive device 10 a relative motion can be created between specimen holder 13 and sectioning knife 11, and a cut can thus be made.

Cassette retaining device 1 comprises a base part 3 having a heat absorber 9, in which part refrigerant lines 8 for cooling cassette 5 are arranged. Refrigerant lines 8 are connected via flexible hose lines (not shown) to a refrigeration system (not shown). This ensures that coolant flows through base part 3 of cassette retaining device 1, which is correspondingly cooled. The heat occurring during sectioning can thus be dissipated via base part 3.

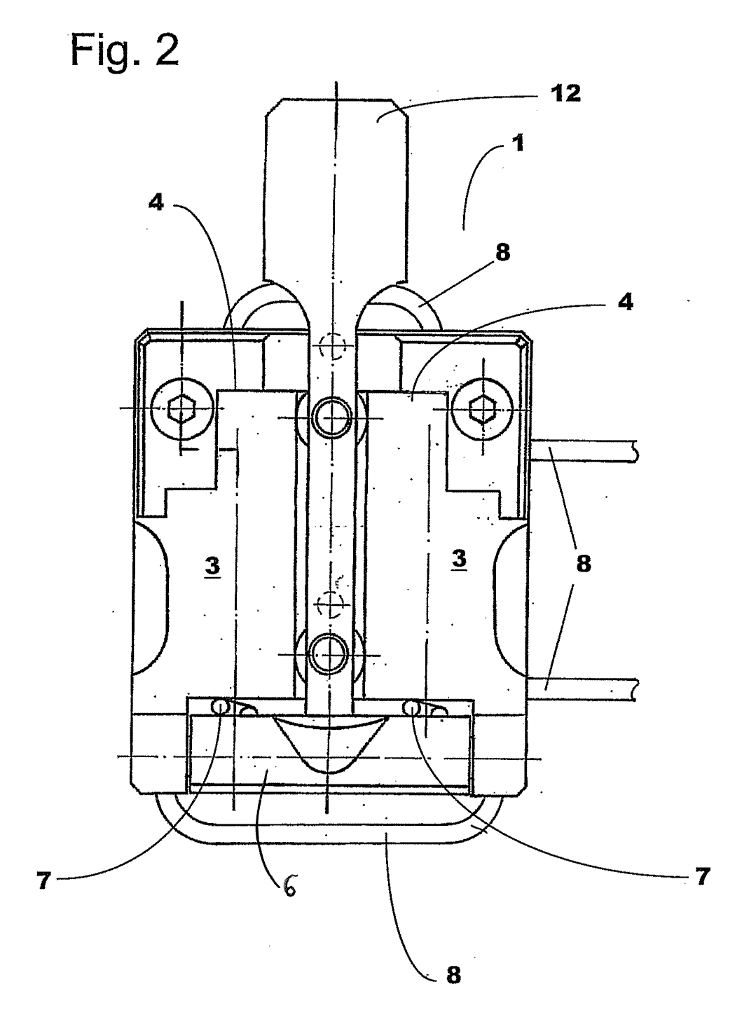

FIG. 2 is a view of cassette retaining device 1 having base part 3 and having refrigerant lines 8 arranged in meander fashion in base part 3. Cassette retaining device 1 comprises multiple stops 4 and a movably mounted clamping jaw 6. A cassette (not depicted here) can be retained between the stationary stops 4 and the movable clamping jaw 6. Associated with the movable clamping jaw 6 are a retaining lever 12 and two springs 7 by means of which clamping jaw 6 is movably embodied. An exhaustive description of the manner of operation of the clamping mechanism is disclosed in DE 198 16375 C1, and its counterpart U.S. Pat. No. 6,231,037 B1, the disclosure of which is incorporated herein by reference.

### PARTS LIST

1 Cassette retaining device

2 Microtome

3 Base part

4 Stops

5 Cassette

6 Clamping jaw

7 Springs

8 Refrigerant line

9 Heat absorber

10 Drive device

11 Sectioning knife

12 Retaining lever

13 Specimen holder

What is claimed is:

1. A cassette retaining device (1) for a microtome (2), the retaining device comprising:
a base part (3) including stationary stops (4) for positioning a cassette and at least one movably mounted clamping jaw (6) opposite the stops (4), whereby a cassette is retained between the stops (4) and the clamping jaw (6); and
a refrigerant line (8) associated with the base part for carrying coolant to promote cooling of a cassette retained by the retaining device.

2. The cassette retaining device (1) according to claim 1, wherein the base part (3) is made from a highly thermally conductive material.

3. The cassette retaining device (1) according to claim 2, wherein the base part (3) is made from brass.

4. The cassette retaining device (1) according to claim 1, further comprising a heat absorber (9) associated with the base part (3).

5. The cassette retaining device (1) according to claim 1, wherein the refrigerant line (8) is integrated into the base part (3).

6. The cassette retaining device (1) according to claim 1, wherein the refrigerant line (8) is extends in different directions in the base part (3).

7. The cassette retaining device (1) according to claim 5, wherein the base part (3) including the refrigerant line (8) is a retrofittable component that is connectable to the cassette retaining device (1).
